(19) United States
(12) Patent Application Publication
(10) Pub. No.: US 2022/0324570 A1
(43) Pub. Date: Oct. 13, 2022

(54) FLIGHT CONROL METHOD AND DEVICE, UNMANNED AERIAL VEHICLE

(71) Applicant: AUTEL ROBOTICS CO., LTD., Shenzhen (CN)

(72) Inventor: Tianbao ZHANG, Shenzhen (CN)

(21) Appl. No.: 17/854,999

(22) Filed: Jun. 30, 2022

Related U.S. Application Data
(63) Continuation of application No. PCT/CN2020/133965, filed on Dec. 4, 2020.

(30) Foreign Application Priority Data
Dec. 31, 2019 (CN) 201911415937.4

(51) Int. Cl. B64C 39/02; G05D 1/08; G05D 1/00

(52) U.S. Cl. CPC B64C 39/024; G05D 1/0808; G05D 1/0016; B64C 2201/146; B64C 2201/127

(57) ABSTRACT

Embodiments of the present invention are a flight control method and device, and an unmanned aerial vehicle. The method comprises firstly acquiring the current flight velocity of the unmanned aerial vehicle, then obtaining the current optimum inclination angle corresponding to the unmanned aerial vehicle according to the current flight velocity, and further adjusting the flight state of the unmanned aerial vehicle according to the current optimum inclination angle. The method can relieve the restrictions on the flight freedom of unmanned aerial vehicles and make the user experience rapid flight pleasure.

### CROSS REFERENCE

The present application is a continuation of International Application No. PCT/CN2020/133965, filed on Dec. 4, 2020, which claims priority to Chinese Patent Application No. 201911415937.4, filed on Dec. 31, 2019, which is incorporated herein by reference in its entirety.

### BACKGROUND

### Technical Field

The present invention relates to the technical field of unmanned aerial vehicles, and more particularly to a flight control method and device, and an unmanned aerial vehicle.

### Related Art

With the continuous development of unmanned aircraft aerial photography technology, more and more consumer unmanned aerial vehicles are being developed. Unmanned aerial vehicles are also becoming increasingly popular. The manipulation of unmanned aircraft is done in many ways, such as via remote controls, mobile phones, computers, and like mobile terminals.

The existing consumer unmanned aerial vehicles focus on the stability of aerial photography, and most of the consumers are without unmanned aerial vehicle driving experience, so the flight velocity of the unmanned aerial vehicle is limited when it leaves the factory. For professional unmanned aerial vehicle players, such mandatory restrictions limit flight freedom and the players cannot experience the pleasure of a very fast flight.

### SUMMARY

In order to solve the above-mentioned technical problems, an embodiment of the present invention provides a flight control method and device, and an unmanned aerial vehicle, which enables a user to experience the pleasure of a very fast flight.

In order to solve the above technical problems, an embodiment of the present invention provides the following technical solutions: a flight control method. The flight control method includes: acquiring a current flight velocity of the unmanned aerial vehicle;

obtaining a current optimum inclination angle corresponding to the unmanned aerial vehicle according to the current flight velocity;

and adjusting the flight state of the unmanned aerial vehicle according to the current optimum inclination angle.

Optionally, obtaining a current optimum inclination angle corresponding to the unmanned aerial vehicle according to the current flight velocity comprises:

presetting multiple velocity feature points;

according to the velocity feature points, respectively obtaining tension data and resistance data of each of the velocity feature points at different attitude inclination angles;

and according to the tension data and the resistance data, obtaining the current optimum inclination angle.

Optionally, adjusting the flight state of the unmanned aerial vehicle according to the current optimum inclination angle comprises:

generating target attitude information according to the current optimum inclination angle, wherein the target attitude information comprises a target attitude inclination angle;

and adjusting the current attitude inclination angle of the unmanned aerial vehicle to the target attitude inclination angle.

Optionally, acquiring a limit inclination angle of the unmanned aerial vehicle and a limit velocity corresponding to the limit inclination angle comprises:

judging whether the current attitude angle reaches the limit inclination angle;

if so, adjusting the current flight velocity to the limit velocity; and

if not, continuing to adjust the flight state of the unmanned aerial vehicle according to the current optimum inclination angle corresponding to the current flight velocity.

Optionally, each flight velocity has a corresponding optimum inclination angle;

and acquiring a limit inclination angle of the unmanned aerial vehicle and a limit velocity corresponding to the limit inclination angle comprises:

acquiring a maximum flight velocity corresponding to each of the optimum inclination angles;

and obtaining the limit velocity according to multiple optimum inclination angles and the maximum flight velocity corresponding to each of the optimum inclination angles.

In order to solve the above technical problems, an embodiment of the present invention provides the following technical solutions: a flight control device. The flight control device includes: a current flight velocity acquisition module used for acquiring the current flight velocity of the unmanned aerial vehicle;

a current optimum inclination angle acquisition module used for obtaining the current optimum inclination angle corresponding to the unmanned aerial vehicle according to the current flight velocity;

and a flight state adjusting module used for adjusting the flight state of the unmanned aerial vehicle according to the current optimum inclination angle.

Optionally, the current optimum inclination angle acquisition module comprises a velocity feature point presetting unit, a data acquisition unit, and a current optimum inclination angle calculation unit;

the velocity feature point presetting unit is used for presetting multiple velocity feature points;

the data acquisition unit is used for respectively obtaining the tension data and resistance data of each of the velocity feature points at different attitude inclination angles according to the velocity feature point;

and the current optimum inclination angle calculation unit is used for obtaining the current best inclination according to the tension data and resistance data.

Optionally, the flight state adjustment module further comprises a target attitude information generation unit and an attitude inclination angle adjustment unit;

the target attitude generation unit is used for generating target attitude information according to the current optimum inclination angle, wherein the target attitude information comprises a target attitude inclination angle;

the attitude inclination angle adjustment unit is used for adjusting the current attitude inclination angle of the unmanned aerial vehicle to a target attitude inclination angle.

Optionally, the flight control device further comprises a limit velocity acquisition module and a judgement module;

the limit velocity acquisition module is used for acquiring a limit inclination angle of the unmanned aerial vehicle and a limit velocity corresponding to the limit inclination angle.

The judgement module is used for judging whether the current attitude angle reaches the limit inclination angle; the judgement module is further used for, if yes, adjusting the current flight velocity to the limit velocity, and if not, continuing to adjust the flight state of the unmanned aerial vehicle according to the current optimum inclination angle corresponding to the current flight velocity.

In order to solve the above technical problem, an embodiment of the present invention also provides the following technical solutions: an unmanned aerial vehicle. The unmanned aerial vehicle comprises: a fuselage;

a horn connected to the fuselage;

a power device provided on the horn for providing flying power to the unmanned aerial vehicle; and

a flight controller provided on the fuselage;

wherein the flight controller comprises:

at least one processor; and

a memory communicatively connected to the at least one processor; wherein the memory stores an instruction that can be executed by the at least one processor, and the instruction is executed by the at least one processor, so that the at least one processor is used for executing the flight control method.

Compared with the prior art, the flight control method provided by an embodiment of the present invention includes, firstly acquiring the current flight velocity of the unmanned aerial vehicle, then obtaining the current optimum inclination angle corresponding to the unmanned aerial vehicle according to the current flight velocity, and further adjusting the flight state of the unmanned aerial vehicle according to the current optimum inclination angle. The method can relieve the restrictions on the flight freedom of unmanned aerial vehicles and make the user experience rapid flight pleasure.

### BRIEF DESCRIPTION OF THE DRAWINGS

One or more embodiments are exemplified by the pictures in the corresponding drawings, and these exemplifications do not constitute limitations of the embodiments, and elements with the same reference numerals in the drawings are denoted as similar elements. Unless otherwise stated, the figures in the accompanying drawings do not constitute a scale limitation.

FIG. 1 is a schematic view of an application environment of an embodiment of the present invention;

FIG. 2 is a flow chart of a flight control method according to one of the embodiments of the present invention;

FIG. 3 is a flow chart of S20 in FIG. 2;

FIG. 4 is a graph of the horizontal tension-attitude inclination angle and horizontal resistance-attitude inclination angle of an unmanned aerial vehicle according to an embodiment of the present invention;

FIG. 5 is a graph of a velocity feature point-optimum inclination angle curve of an unmanned aerial vehicle according to an embodiment of the present invention;

FIG. 6 is a flow chart of S30 in FIG. 2;

FIG. 7 is a flow chart of a flight control method according to another embodiment of the present invention;

FIG. 8 is a flow chart of S40 in FIG. 7;

FIG. 9 is a block diagram of a structure of a flight control device according to an embodiment of the present invention;

FIG. 10 is a block diagram of a structure of an unmanned aerial vehicle according to an embodiment of the present invention.

### DETAILED DESCRIPTION

In order to facilitate the understanding of the present invention, the present invention will be described in more detail below with reference to the accompanying drawings and specific embodiments. It should be noted that when an element is referred to as being “fixed to” another element, it can be directly on the other element, or one or more intervening elements may be present therebetween. When an element is referred to as being “connected” to another element, it can be directly connected to the other element or one or more intervening elements may be present therebetween. As used in this description, orientations or positional relationships indicated by the terms “upper”, “lower”, “inner”, “outer”, “bottom”, and the like are based on the orientation or positional relationships shown in the figures, and are merely for the convenience in describing the invention and to simplify the description, and do not indicate or imply that the device or element being referred to must have a particular orientation or be constructed and operated in a particular orientation, and are thus not to be construed as limiting the invention. Furthermore, the terms “first”, “second”, “third”, and the like are used for descriptive purposes only and are not to be construed as indicating or implying relative importance.

Unless defined otherwise, all technical and scientific terms used in the description have the same meaning as commonly understood by one of ordinary skills in the art to which this invention belongs. The terms used in the description of the present invention in this description are only for the purpose of describing specific embodiments, and are not used to limit the present invention. As used herein, the term “and/or” includes any and all combinations of one or more of the associated listed items.

Furthermore, the technical features of the various embodiments of the present invention described below can be combined as long as they do not conflict with each other.

Embodiments of the present invention provide a flight control method and device, which can acquire the current flight velocity of the unmanned aerial vehicle first, then according to the current flight velocity, obtain the current optimal inclination angle corresponding to the unmanned aerial vehicle, and then according to the current optimal inclination angle, adjust the flight state of the unmanned aerial vehicle. The method can relieve the restrictions on the flight freedom of unmanned aerial vehicles and make the user experience rapid flight pleasure.

The application environment of the flight control method and device is exemplified below.

FIG. 1 is a schematic view of an application environment of a flight control system provided by an embodiment of the present invention; as shown in FIG. 1, the application scenario includes an unmanned aerial vehicle 10, a wireless network 20, an intelligent terminal 30, and a user 40. The user 40 can operate the intelligent terminal 30 to manipulate the unmanned aerial vehicle 10 through the wireless network 20.

The unmanned aerial vehicle 10 may be any type of a powered unmanned flight carrier, including, but not limited to, a rotor-wing unmanned aerial vehicle, a fixed-wing unmanned aerial vehicle, a para-wing unmanned aerial vehicle, a flapping-wing unmanned aerial vehicle, a helicopter model, and the like. In this embodiment, a multi-rotor-wing unmanned aerial vehicle is used as an example.

The unmanned aerial vehicle 10 can have a corresponding volume or power according to the requirements of actual situations, so as to provide a load capacity, a flight velocity, a flight endurance mileage, and the like which can meet the use requirements. One or more functional modules may also be added to the unmanned aerial vehicle 10 to enable the unmanned aerial vehicle 10 to realize the corresponding functions.

For example, in the present embodiment, the unmanned aerial vehicle 10 is provided with at least one sensor of an accelerometer, a gyroscope, a magnetometer, a GPS navigator, and a vision sensor. Accordingly, the unmanned aerial vehicle 10 is provided with an information receiving device for receiving and processing the information collected by at least one kind of sensors.

The unmanned aerial vehicle 10 comprises at least one main control chip as a control core of flight and data transmission, etc. of the unmanned aerial vehicle, and integrates one or more modules to execute the corresponding logic control programs.

For example, in some embodiments, the master control chip may include a flight control device 90 thereon for selecting and processing a course angle.

The intelligent terminal 30 can be any type of intelligent devices used to establish a communication connection with the unmanned aerial vehicle 10, such as a mobile phone, a tablet computer, or a smart remote control, etc. The intelligent terminal 30 may be equipped with one or more different user 40 interactive devices for collecting user 40 instructions or presenting and feeding back information to the user 40.

These interactive devices include, but are not limited to: keys, display screens, touch screens, speakers, and remote control operating arms. For example, the intelligent terminal 30 can be equipped with a touch control display screen, and a remote control instruction from the user 40 to the unmanned aerial vehicle 10 is received via the touch control display screen and the image information obtained by aerial photography is displayed to the user 40 via the touch control display screen; the user 40 can also switch the image information currently displayed on the display screen via remote controlling a touch screen.

In some embodiments, the unmanned aerial vehicle 10 and the intelligent terminal 30 can also integrate existing image vision processing technology therebetween to further provide more intelligent services. For example, the unmanned aerial vehicle 10 can collect images through a bifocal camera, and the intelligent terminal 30 parses the images, thereby realizing the gesture control of the unmanned aerial vehicle 10 by the user 40.

The wireless network 20 may be a wireless communication network based on any type of data transmission principle for establishing a data transmission channel between two nodes, such as a Bluetooth network, a WiFi network, a wireless cellular network, or a combination thereof located in different signal bands.

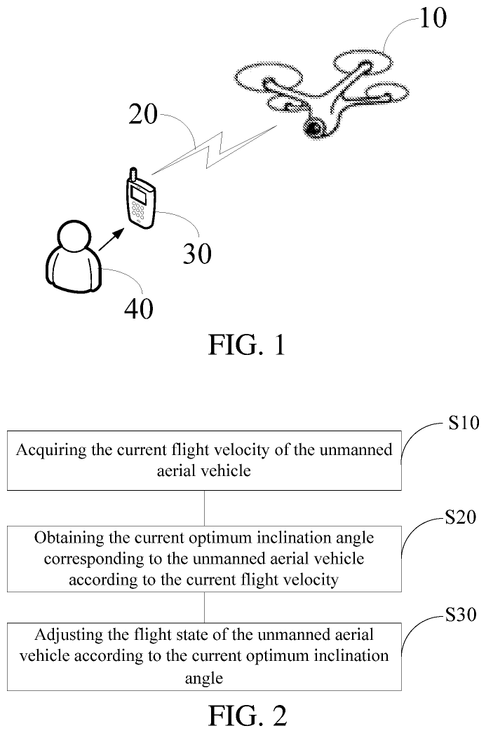

FIG. 2 is an embodiment of a flight control method provided by an embodiment of the present invention. As shown in FIG. 2, the flight control method includes the steps:

S10: acquiring the current flight velocity of the unmanned aerial vehicle.

Specifically, the unmanned aerial vehicle is an unmanned unmanned-aerial-vehicle operated with a radio remote control apparatus and a self-contained program control device. In general, GPS positioning system and inertial measurement system are combined to achieve the flight control of an unmanned aerial vehicle. Without GPS, the flight velocity of the unmanned aerial vehicle is needed to be acquired to control the flight state of the unmanned aerial vehicle.

At present, in the case of no GPS, image data is collected by means of a camera installed at the bottom of the unmanned aerial vehicle, and then the pyramid optical flow algorithm or block matching optical flow algorithm is used to calculate the movement vector of two frames of the image, and then the optical flow velocity is obtained, and finally, the current flight velocity of the unmanned aerial vehicle can be calculated according to the height and optical flow velocity acquired according to a height measurement sensor.

In the present embodiment, the current flight velocity of the unmanned aerial vehicle is acquired by the following method. Firstly, the image information is acquired, and the gray-scale processing is performed to acquire an image grey-scale map. The real-time image information about the ground is acquired by an image sensor, and the acquired real-time image information is subjected to grey-scale processing so as to acquire a continuous image grey-scale map. Then the pyramid optical flow algorithm is used to acquire the optical flow velocity, and the flight velocity of the unmanned aerial vehicle is acquired according to the optical flow velocity and the altitude data of the unmanned aerial vehicle. It should be noted that the pyramid optical flow algorithm relates the two-dimensional velocity field with the gray scale, introduces the optical flow constraint equation, and obtains the basic algorithm of optical flow calculation. Two assumptions are made based on the optical properties of the object movement: (1) the gray scale of the moving object remains unchanged within a short interval; (2) if time continues or the movement is a small movement, the movement of an image over time is relatively slow, meaning in practice that the ratio of time variation to the movement in the image is small enough. The image grey-scale map is then updated while determining whether the flight velocity is greater than a first threshold. When the flight velocity is greater than a first threshold, switching to a block matching optical flow algorithm to acquire an optical flow velocity, and otherwise continuing to use the pyramid optical flow algorithm to acquire an optical flow velocity. Finally, the current flight velocity of the unmanned aerial vehicle is acquired according to the optical flow velocity and the altitude data of the unmanned aerial vehicle.

S20: obtaining the current optimum inclination angle corresponding to the unmanned aerial vehicle according to the current flight velocity.

Specifically, each flight velocity of the unmanned aerial vehicle corresponds to a corresponding optimum inclination angle. In the present embodiment, the optimum inclination angle can be acquired by the following mode: firstly, presetting multiple velocity feature points, then respectively obtaining the tension data and resistance data of each velocity feature point at different attitude inclination angles according to the velocity feature points, and then obtaining an optimum inclination angle corresponding to each flight velocity according to the tension data and resistance data. Therefore, the current optimum inclination angle corresponding to the unmanned aerial vehicle can be obtained according to the acquired current flight velocity.

S30: adjusting the flight state of the unmanned aerial vehicle according to the current optimum inclination angle.

Specifically, firstly, the target attitude information is generated according to the current optimum inclination angle, wherein the target attitude information comprises a target attitude inclination angle, and then the current attitude angle of the unmanned aerial vehicle is adjusted to the target attitude inclination angle, and finally, the adjustment of the flight state of the unmanned aerial vehicle is realized.

In this embodiment, by acquiring the flight environment information of the unmanned aerial vehicle, and then eliminating the influence of the external environment on the magnetometer according to the flight environment information, the magnetometer can give a more accurate initial value of the heading angle to provide the unmanned aerial vehicle for data fusion, so that the unmanned aerial vehicle can take off in the ground environment with magnetic interference, and the heading angle still has a certain degree of accuracy, thereby reducing the blasting probability of the unmanned aerial vehicle taking off in the ground environment with magnetic interference, and improving the flight safety.

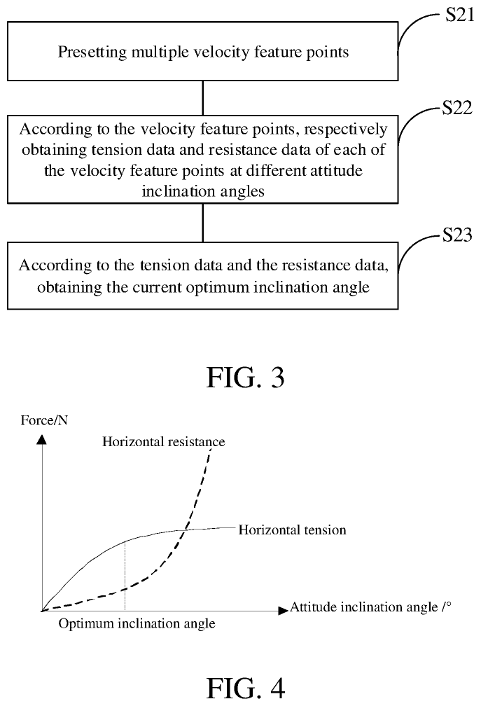

In order to obtain a current optimum inclination angle corresponding to the unmanned aerial vehicle according to the current flight velocity better, referring to FIG. 3, S20 includes the following steps:

S21: presetting multiple velocity feature points.

Specifically, the velocity feature points are different flight velocities of the unmanned aerial vehicle, for example 2 m/s, 4 m/s, 6 m/s, 8 m/s, 10 m/s, 12 m/s, 14 m/s, 16 m/s, 18 m/s, and 20 m/s.

S22: according to the velocity feature points, respectively obtaining tension data and resistance data of each of the velocity feature points at different attitude inclination angles.

Specifically, as shown in FIG. 4, the tension data and resistance data of each of the velocity feature points at different attitude inclination angles are obtained through experiments at different velocity feature points, respectively. By way of example, the tension data and resistance data at 4 m/s, 6 m/s, 8 m/s, 10 m/s, 12 m/s, 14 m/s, 16 m/s, 18 m/s, and 20 m/s can be acquired by a limited number of implementations, respectively.

S23: according to the tension data and the resistance data, obtaining the current optimum inclination angle.

Under the premise of stable height, when the motor tension of the unmanned aerial vehicle is reasonably depleted, the maximum velocities that the unmanned aerial vehicle can reach at different attitude inclination angles are different, the optimum inclination angle here means that the fastest unmanned aerial vehicle can reach the maximum velocity when flying at this inclination angle, and the maximum velocity that can be reached at this inclination angle can not reached at any other inclination angle.

Specifically, as shown in FIG. 4, the tension data and resistance data of each of the velocity feature points at different attitude inclination angles are drawn into the horizontal tension-attitude inclination angle and horizontal resistance-attitude inclination angle curves respectively, and then an optimum inclination angle corresponding to each of the velocity feature points is obtained according to the horizontal tension-attitude inclination angle and horizontal resistance-attitude inclination angle curves, wherein the optimum inclination angle is the inclination angle with the maximum difference between the horizontal tension and the horizontal resistance.

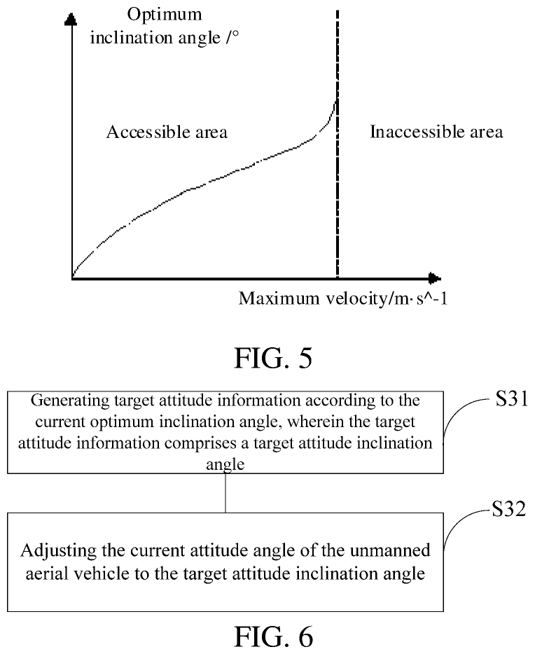

Since the optimum inclination angles at different velocities have been obtained by means of experiments, and this is made into a numerical value interpolation table and stored in the unmanned aerial vehicle, the curve shown in FIG. 5 is obtained by means of fitting. When the unmanned aerial vehicle flies, the velocity will continue to increase, and the control unit of the unmanned aerial vehicle will look for the optimum inclination angle in real-time through the current velocity to adjust the unmanned aerial vehicle to fly. This way of acceleration is the fastest, and it ensures that the unmanned aerial vehicle can fly to the maximum velocity.

As shown in FIG. 5, multiple velocity feature points and the corresponding optimum inclination angles are drawn into a velocity feature point-optimum inclination angle curve, and then the current optimum inclination angle corresponding to the current flight velocity can be obtained according to the velocity feature point-optimum inclination angle curve.

By way of example, the tension data and resistance data at 4 m/s, 6 m/s, 8 m/s, 10 m/s, 12 m/s, 14 m/s, 16 m/s, 18 m/s, and 20 m/s obtained by a limited number of experiments are drawn into horizontal tension-attitude inclination angle and horizontal resistance-attitude inclination angle curves, respectively. Then the optimum inclination angles 01, 02, 03, 04, 05, 06, 07, 08, and 09 corresponding to each of the velocity feature points 4 m/s, 6 m/s, 8 m/s, 10 m/s, 12 m/s, 14 m/s, 16 m/s, 18 m/s and 20 m/s are obtained according to the horizontal tension-attitude inclination angle and horizontal resistance-attitude inclination angle curves, and then the optimum inclination angles θ1, θ2, θ3, θ4, θ5, θ6, θ7, θ8, and θ9 corresponding to 4 m/s, 6 m/s, 8 m/s, 10 m/s, 12 m/s, 14 m/s, 16 m/s, 18 m/s, and 20 m/s are drawn into a velocity feature point-optimum inclination angle curve, and then the current optimum inclination angle corresponding to the current flight velocity can be obtained according to the velocity feature point-optimum inclination angle curve.

In order to better adjust the flight state of the unmanned aerial vehicle according to the current optimum inclination angle, referring to FIG. 6, S30 includes the following steps:

S31: generating target attitude information according to the current optimum inclination angle, wherein the target attitude information comprises a target attitude inclination angle;

and S32: adjusting the current attitude angle of the unmanned aerial vehicle to the target attitude inclination angle.

Specifically, when the unmanned aerial vehicle accelerates by a user hitting a stick, the velocity of the unmanned aerial vehicle gradually increases. According to the current flight velocity, a corresponding optimum inclination angle is searched and sent to the unmanned aerial vehicle as the current optimum inclination angle, and then the target attitude information is generated according to the current optimum inclination angle, wherein the target attitude information comprises the target attitude inclination angle. The unmanned aerial vehicle's automatic control system adjusts the rotation velocity of the motor to control the current attitude inclination angle of the unmanned aerial vehicle so that the current attitude inclination angle is stably controlled near the desired attitude inclination angle.

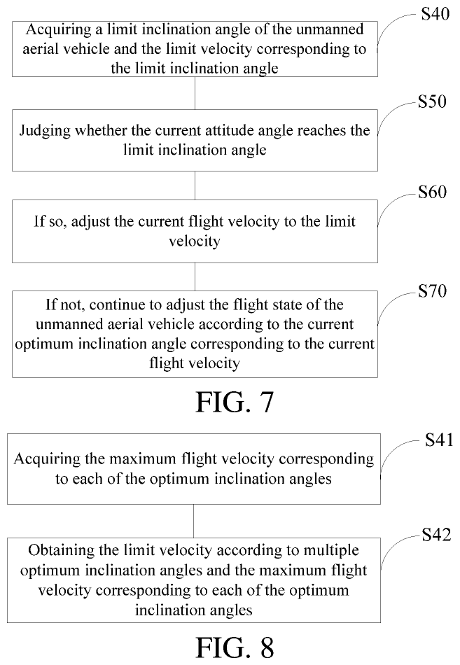

For better flight control of an unmanned aerial vehicle, in some embodiments, referring to FIG. 7, the method further comprises the steps:

S40: acquiring a limit inclination angle of the unmanned aerial vehicle and a limit velocity corresponding to the limit inclination angle.

Specifically, when the unmanned aerial vehicle flies to a greater velocity, it is not that the greater the attitude inclination angle, the better. After a certain inclination angle is exceeded, the velocity of the aircraft will decrease instead. This inclination angle is the limit inclination angle of the aircraft, and the velocity that can be achieved at this inclination angle is called the limit velocity.

Specifically, the maximum flight velocity corresponding to each of the optimum inclination angles is acquired, and then the curve of the maximum flight velocity at different optimum inclination angles as shown in FIG. 5 is drawn according to multiple optimum inclination angles and the maximum flight velocity corresponding to each of the optimum inclination angles, and the limit velocity can be obtained from the curve of the maximum flight velocity at different optimum inclination angles.

S50: judging whether the current attitude angle reaches the limit inclination angle.

S60: if so, adjusting the current flight velocity to the limit velocity.

S70: if not, continuing to adjust the flight state of the unmanned aerial vehicle according to the current optimum inclination angle corresponding to the current flight velocity.

In order to better acquire the limit inclination angle of the unmanned aerial vehicle and the limit velocity corresponding to the limit inclination angle, in some embodiments, referring to FIG. 8, S40 comprises the following steps:

S41: acquiring the maximum flight velocity corresponding to each of the optimum inclination angles.

S42: obtaining the limit velocity according to multiple optimum inclination angles and the maximum flight velocity corresponding to each of the optimum inclination angles.

It should be noted that in the above-mentioned embodiments, there is not necessarily a certain order between the above-mentioned steps, and a person of ordinary skills in the art can understand from the description of the embodiments of the present application that in different embodiments, the above steps may have different execution orders, that is, they may be executed in parallel or interchangeably, etc.

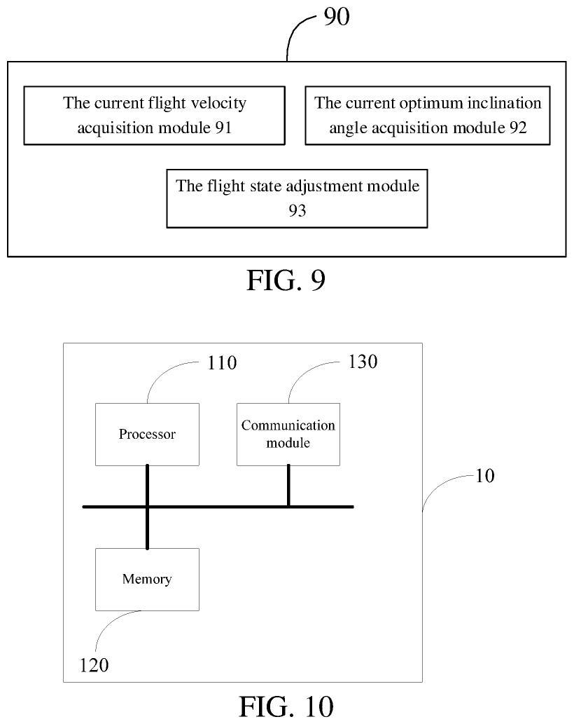

As another aspect of embodiments of the present application, embodiments of the present application provide a flight control device 90. Referring to FIG. 9, the flight control device 90 includes a current flight velocity acquisition module 91, a current optimum inclination angle acquisition module 92, and a flight state adjustment module 93.

The current flight velocity acquisition module 91 is used for acquiring the current flight velocity of the unmanned aerial vehicle.

The current optimum inclination angle acquisition module 92 is used for obtaining the current optimum inclination angle corresponding to the unmanned aerial vehicle according to the current flight velocity.

The flight state adjusting module 93 is used for adjusting the flight state of the unmanned aerial vehicle according to the current optimum inclination angle.

Therefore, in the present embodiment, the following steps are included, firstly acquiring the current flight velocity of the unmanned aerial vehicle, then obtaining the current optimum inclination angle corresponding to the unmanned aerial vehicle according to the current flight velocity, and further adjusting the flight state of the unmanned aerial vehicle according to the current optimum inclination angle. The method can relieve the restrictions on the flight freedom of unmanned aerial vehicles and make the user experience rapid flight pleasure.

In some embodiments, the current optimum inclination angle acquisition module 92 comprises a velocity feature point presetting unit, a data acquisition unit, and a current optimum inclination angle calculation unit.

The velocity feature point presetting unit is used for presetting multiple velocity feature points.

The data acquisition unit is used for respectively obtaining the tension data and resistance data of each of the velocity feature points at different attitude inclination angles according to the velocity feature point.

The current optimum inclination angle calculation unit is used for obtaining the current best inclination according to the tension data and resistance data.

In some embodiments, the flight state adjustment module 93 further includes a target attitude information generation unit and an attitude tilt adjustment unit.

The target attitude generation unit is used for generating target attitude information according to the current optimum inclination angle, wherein the target attitude information comprises a target attitude inclination angle.

The attitude inclination angle adjustment unit is used for adjusting the current attitude inclination angle of the unmanned aerial vehicle to a target attitude inclination angle.

The flight control device 90 further comprises a limit velocity acquisition module and a judgement module;

the limit velocity acquisition module is used for acquiring a limit inclination angle of the unmanned aerial vehicle and a limit velocity corresponding to the limit inclination angle.

The judgement module is used for judging whether the current attitude angle reaches the limit inclination angle; the judgement module is further used for, if yes, adjusting the current flight velocity to the limit velocity, and if not, continuing to adjust the flight state of the unmanned aerial vehicle according to the current optimum inclination angle corresponding to the current flight velocity.

FIG. 10 is a schematic view showing the structure of an unmanned aerial vehicle according to an embodiment of the present application. The unmanned aerial vehicle 10 may be any type of unmanned vehicles capable of executing the image exposing method according to the corresponding method embodiment or operating the flight control device 90 according to the corresponding device embodiment. The unmanned aerial vehicle comprises a fuselage, a horn, a power device, an infrared emission device, a flight control module 110, a memory 120, and a communication module 130.

The horn is connected to the fuselage; the power device is provided on the horn for providing the unmanned aerial vehicle with flight power; the infrared emitting device is arranged in the fuselage and is used for sending infrared access information and receiving an infrared control instruction sent by a remote control device;

the flight control module has the capability to monitor, operate and manipulate unmanned aerial vehicle flights and missions, including a set of apparatuses for controlling the launching and recovery of the unmanned aerial vehicle. The flight control module may also modulate a binary digital signal into an infrared signal in the form of a corresponding optical pulse or demodulate an infrared signal in the form of optical pulses into a binary digital signal.

The flight control module 110, the memory 120, and the communication module 130 establish a communication connection between any of the two by means of a bus.

The flight control module 110 may be any type of a flight control module 110 having one or more processing cores. It may execute single-threaded or multi-threaded operations for parsing instructions to execute operations such as acquiring data, executing logical operation functions, and delivering operation and processing results.

As a non-transitory computer-readable storage medium, the memory 120 can be used for storing a non-transitory software program, a non-transitory computer-executable program, and a module, such as a program instruction/module corresponding to an image exposing method in an embodiment of the present invention (for example, current flight velocity acquisition module 91, current optimum inclination angle acquisition module 92 and flight state adjustment module 93 shown in FIG. 9). The flight control module 110 executes various functional applications and data processing of the flight control device 90 by operating non-transient software programs, instructions, and modules stored in the memory 120, i.e. implementing the image exposing method in any of the method embodiments described above.

The memory 120 can comprise a program storage area and a data storage area. The program storage area can store an operating system and an application program required by at least one function; the stored data area may store data created from the use of the flight control device 90, etc. In addition, memory 120 may include high-velocity random access memory and may also include non-transitory memory, such as at least one disk storage device, flash memory device, or other non-transitory solid-state storage devices. In some embodiments, the memory 120 may optionally include memory remotely provided with respect to the flight control module 110. These remote control memories may be connected to the unmanned aerial vehicle 10 via a network. Examples of such networks include, but are not limited to, the Internet, intranet, local area network, mobile communication network, and combinations thereof.

The memory 120 stores instructions executable by at least one flight control module 110; at least one flight control module 110 is configured to execute the instruction to implement the image exposing method in any of the method embodiments described above, e.g. to execute step 10, step 20, step 30, etc. of the methods described above to implement the functions of modules 91-93 in FIG. 9.

The communication module 130 is a functional module for establishing a communication connection and providing a physical channel. The communication module 130 may be any type of wireless or wired communication module 130 including, but not limited to, a WiFi module or a Bluetooth module, etc.

Further, an embodiment of the present invention also provides a non-transitory computer-readable storage medium storing computer-executable instructions. The computer-executable instruction is executed by one or more flight control modules 110, for example, by a flight control module 110 in FIG. 10, so that the above one or more flight control modules 110 can execute the image exposing method in any of the above method embodiments, for example, executing step 10, step 20, step 30, etc. of the methods described above to implement the functions of modules 91-93 in FIG. 9.

The device embodiments described above are merely illustrative. The units described as separate components may or may not be physically separated, and components displayed as units may or may not be physical units, that is, may be located in one place, or distributed to multiple network units. Some or all of the modules may be selected according to actual needs to achieve the object of the implementation schemes.

From the description of the above implementation schemes, those of ordinary skills in the art can clearly understand that each implementation scheme can be implemented by means of software plus a general hardware platform, and certainly can also be implemented by hardware. It will be appreciated by those of ordinary skill in the art that implementing all or part of the flow of the above-described embodiment methods may be accomplished by a computer program in a computer program product to instruct relevant hardware, the computer program being stored in one non-transitory computer-readable storage medium, and the computer program including program instructions which, when executed by a relevant apparatus, cause the relevant apparatus to execute the flow of the above-described method embodiments. The storage medium may be a magnetic disk, an optical disk, a Read-Only Memory (ROM), or a Random Access Memory (RAM), etc.

The above-mentioned product can execute the image exposure method provided by an embodiment of the present invention, and has the corresponding functional modules and advantageous effects for executing the image exposure method. Technical details not described in detail in this embodiment can be referred to the image exposure method provided in the embodiments of the present invention.

The present invention is described with reference to flowcharts and/or block diagrams of methods, apparatus (systems), and computer program products according to embodiments of the invention. It will be understood that each flow and/or block of the flowcharts and/or block diagrams, and combinations of flows and/or blocks in the flowcharts and/or block diagrams, can be implemented by computer program instructions. These computer program instructions may be provided to a processor of a general purpose computer, special purpose computer, embedded processor, or other programmable data processing apparatuses to produce a machine such that the instructions, which executed via the processor of the computer or other programmable data processing apparatuses, create device for implementing the functions specified in one or more flows in flowcharts and/or one or more blocks in block diagrams.

These computer program instructions may also be loaded onto a computer or other programmable data processing apparatuses to cause a series of operational steps to be executed on the computer or other programmable apparatuses to produce a computer-implemented process such that the instructions executed on the computer or other programmable apparatuses provide steps for implementing the functions specified in one or more flows in flowcharts and/or one or more blocks in block diagrams.

The above descriptions are only preferred embodiments of the present invention and are not intended to limit the present invention. Any modifications, equivalent replacements and improvements made within the spirit and principles of the present invention shall be included in the scope of the present invention.

Finally, it should be noted that: the above embodiments are merely illustrative of the technical solutions of the present invention, rather than limiting it; combinations of technical features in the above embodiments or in different embodiments are also possible within the spirit of the invention, the steps can be implemented in any order, and there are many other variations of the different aspects of the invention described above, which are not provided in detail for the sake of brevity; although the present invention has been described in detail with reference to the foregoing embodiments, those skilled in the art will appreciate that: the technical solutions disclosed in the above-mentioned embodiments can still be modified, or some of the technical features thereof can be replaced by equivalents; such modifications or substitutions do not make the essence of the corresponding technical solutions deviate from the scope of the technical solutions of the embodiments of the present invention.

1. A flight control method applied to an unmanned aerial vehicle, comprising:
acquiring a current flight velocity of the unmanned aerial vehicle;
obtaining a current optimum inclination angle corresponding to the unmanned aerial vehicle according to the current flight velocity;
and adjusting a flight state of the unmanned aerial vehicle according to the current optimum inclination angle.

2. The method according to claim 1, wherein the obtaining a current optimum inclination angle corresponding to the unmanned aerial vehicle according to the current flight velocity comprises:
presetting multiple velocity feature points;
according to the velocity feature points, respectively obtaining tension data and resistance data of each of the velocity feature points at different attitude inclination angles;
and according to the tension data and the resistance data, obtaining the current optimum inclination angle.

3. The method according to claim 2, wherein the adjusting a flight state of the unmanned aerial vehicle according to the current optimum inclination angle comprises:
generating target attitude information according to the current optimum inclination angle, wherein the target attitude information comprises a target attitude inclination angle;
and adjusting the current attitude inclination angle of the unmanned aerial vehicle to the target attitude inclination angle.

4. The method according to claim 2, further comprising:
acquiring a limit inclination angle of the unmanned aerial vehicle and a limit velocity corresponding to the limit inclination angle;
and judging whether the current attitude angle reaches the limit inclination angle;
if so, adjusting the current flight velocity to the limit velocity; and
if not, continuing to adjust the flight state of the unmanned aerial vehicle according to the current optimum inclination angle corresponding to the current flight velocity.

5. The method according to claim 4, wherein
each flight velocity has a corresponding optimum inclination angle;
and acquiring a limit inclination angle of the unmanned aerial vehicle and a limit velocity corresponding to the limit inclination angle comprises:
acquiring a maximum flight velocity corresponding to each of the optimum inclination angles;
and obtaining the limit velocity according to multiple optimum inclination angles and the maximum flight velocity corresponding to each of the optimum inclination angles.

6. A flight control device, comprising:
at least one processor; and
a memory communicatively connected to the at least one processor; wherein the memory stores an instruction that can be executed by the at least one processor, and the instruction is executed by the at least one processor to cause the at least one processor to be configured to:
acquire a current flight velocity of the unmanned aerial vehicle;
obtain a current optimum inclination angle corresponding to the unmanned aerial vehicle according to the current flight velocity;
and adjust flight state of the unmanned aerial vehicle according to the current optimum inclination angle.

7. The flight control device according to claim 6, wherein
the at least one processor is further configured to:
preset multiple velocity feature points;
according to the velocity feature points, respectively obtain tension data and resistance data of each of the velocity feature points at different attitude inclination angles;
and according to the tension data and the resistance data, obtain the current optimum inclination angle.

8. The flight control device according to claim 7, wherein
the at least one processor is further configured to:
generate target attitude information according to the current optimum inclination angle, wherein the target attitude information comprises a target attitude inclination angle;
and adjust the current attitude inclination angle of the unmanned aerial vehicle to the target attitude inclination angle.

9. The flight control device according to claim 8, wherein
the at least one processor is further configured to:
acquire a limit inclination angle of the unmanned aerial vehicle and a limit velocity corresponding to the limit inclination angle;
and judge whether the current attitude angle reaches the limit inclination angle; if yes, adjust the current flight velocity to the limit velocity, and if not, continuing to adjust the flight state of the unmanned aerial vehicle according to the current optimum inclination angle corresponding to the current flight velocity.

10. The flight control device according to claim 9, wherein each flight velocity corresponds to a respective optimum inclination angle;
the at least one processor is further configured to:
acquire a maximum flight velocity corresponding to each of the optimum inclination angles;
and obtain the limit velocity according to multiple optimum inclination angles and the maximum flight velocity corresponding to each of the optimum inclination angles.

11. An unmanned aerial vehicle, comprising:
a fuselage;
a horn connected to the fuselage;
a power device provided on the horn for providing flying power to the unmanned aerial vehicle; and
a flight controller provided on the fuselage;
wherein the flight controller comprises:
at least one processor; and
a memory communicatively connected to the at least one processor; wherein the memory stores an instruction that can be executed by the at least one processor, and the instruction is executed by the at least one processor, so that the at least one processor to cause the at least one processor to be configured to:
acquire a current flight velocity of the unmanned aerial vehicle;
obtain a current optimum inclination angle corresponding to the unmanned aerial vehicle according to the current flight velocity;
and adjust a flight state of the unmanned aerial vehicle according to the current optimum inclination angle.

12. The unmanned aerial vehicle according to claim 11, wherein the at least one processor is further configured to:
preset multiple velocity feature points;
according to the velocity feature points, respectively obtain tension data and resistance data of each of the velocity feature points at different attitude inclination angles;
and according to the tension data and the resistance data, obtain the current optimum inclination angle.

13. The unmanned aerial vehicle according to claim 12, wherein the at least one processor is further configured to:
generate target attitude information according to the current optimum inclination angle, wherein the target attitude information comprises a target attitude inclination angle;
and adjust the current attitude inclination angle of the unmanned aerial vehicle to the target attitude inclination angle.

14. The unmanned aerial vehicle according to claim 12, wherein the at least one processor is further configured to:
acquire a limit inclination angle of the unmanned aerial vehicle and a limit velocity corresponding to the limit inclination angle;
and judge whether the current attitude angle reaches the limit inclination angle;
if so, adjusting the current flight velocity to the limit velocity; and
if not, continuing to adjust the flight state of the unmanned aerial vehicle according to the current optimum inclination angle corresponding to the current flight velocity.

15. The unmanned aerial vehicle according to claim 14, wherein each flight velocity corresponds to a respective optimum inclination angle;
and the at least one processor is further configured to:
acquire a maximum flight velocity corresponding to each of the optimum inclination angles;
and obtain the limit velocity according to multiple optimum inclination angles and the maximum flight velocity corresponding to each of the optimum inclination angles.
